(19) United States
(12) Patent Application Publication
(10) Pub. No.: US 2005/0005301 A1
(43) Pub. Date: Jan. 6, 2005

(54) Method and apparatus for determining motion compensation mode

(75) Inventors: Byung-cheol Song, Suwon-si (KR); Jun-hyuk Ko, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/790,138

(22) Filed: Mar. 2, 2004

(30) Foreign Application Priority Data
Jul. 1, 2003 (KR) 2003-44344

(51) Int. Cl. H04N 7/173

(52) U.S. Cl. 725/90

(57) ABSTRACT

A method and apparatus for determining motion compensation (MC) which estimates an interpolative MC mode by a forward and backward MC are provided. The method includes: (a) receiving as inputs a forward frame sum of absolute difference (SAD), a sum of a forward top field SAD and a forward bottom field SAD, a backward frame SAD, and a sum of a backward top field SAD and a backward bottom field SAD; (b) identifying a minimum value among the inputs received in step (a); (c) if the minimum value is smaller than a predetermined threshold value, selecting an MC mode corresponding to the minimum value; and (d) if the minimum value is not smaller than the predetermined threshold value, selecting one of an interpolative field MC mode and an interpolative frame MC mode.

### BACKGROUND OF THE INVENTION

This application claims the priority of Korean Patent Application No. 2003-44344, filed on Jul. 1, 2003, in the Korean Intellectual Property Office, the disclosure of which is incorporated herein in its entirety by reference.

1. Field of the Invention

The present invention relates to Moving Picture Experts Group-2 (MPEG-2) picture encoding, and more particularly, to a method and apparatus for determining motion compensation (MC) which estimate an interpolative motion compensation mode by forward and backward MC.

2. Description of the Related Art

In MPEG-2 pictures, there are three kinds of pictures, I-pictures, B-pictures and P-pictures. In MC of a B-picture, there is forward MC, backward MC and interpolative MC. There are various methods for determining an MC mode for MC of an I-picture. The most general method involves comparing sum of absolute difference (SAD) values obtained from motion estimation (ME) of each mode.

In an MPEG-2 interlaced picture, a frame is composed of a top field and bottom field, and a SAD means a difference of the pixel values between two adjacent fields of the same kind.

However, an interpolative MC should be performed in order to determine an MC mode for a B-picture. Therefore, a considerable amount of computation must be performed and the size of a frame memory increases.

### SUMMARY OF THE INVENTION

The present invention provides a method and apparatus for determining MC mode which determine a final MC mode without performing an interpolative MC.

According to an aspect of the present invention, there is provided a method of determining motion compensation (MC) mode, comprising: (a) receiving as inputs a forward frame sum of absolute difference (SAD), a sum of a forward top field SAD and a forward bottom field SAD, a backward frame SAD, and a sum of a backward top field SAD and a backward bottom field SAD; (b) identifying a minimum value among the inputs received in step (a); (c) if the minimum value is smaller than a predetermined threshold value, selecting an MC mode corresponding to the minimum value; and (d) if the minimum value is not smaller than the predetermined threshold value, selecting one of an interpolative field MC mode and an interpolative frame MC mode.

According to another aspect of the present invention, there is provided an apparatus for determining MC mode, comprising: a sum of absolute difference (SAD) receiving unit which receives as inputs a forward frame SAD, a sum of a forward top field SAD and a forward bottom field SAD, a backward frame SAD, and a sum of a backward top field SAD and a backward bottom field SAD; a minimum value judgment unit which identifies a minimum value among the inputs received by the SAD receiving unit; a first selection unit which selects an MC mode corresponding to the minimum value if the minimum value is smaller than a predetermined threshold value; and a second selection unit which, if the minimum value is not smaller than the predetermined threshold value, selects one of an interpolative field MC mode and an interpolative frame MC mode.

According to another aspect of the present invention, there is provided a picture encoding apparatus comprising: a forward SAD calculation unit which calculates a forward frame SAD, a forward top field SAD, and a forward bottom field SAD; a backward SAD calculation unit which calculates a backward frame SAD, a backward top field SAD, and a backward bottom field SAD; and an MC mode determination unit which receives the SADs as inputs.

According to another aspect of the present invention, there is provided a computer readable medium recording a program for executing the above-described method in a general-purpose computer.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a frame memory and an ME unit for illustrating a conventional method of determining an MC mode of a moving picture encoding apparatus;

FIG. 2 is a block diagram of a moving picture encoding system according to the present invention;

FIG. 3 is a detailed block diagram of an ME/MC unit shown in FIG. 2;

FIG. 4 is a flowchart of a method of determining an MC mode according to the present invention; and

FIG. 5 is a block diagram of an apparatus for determining MC mode according to the present invention.

### DETAILED DESCRIPTION OF THE ILLUSTRATIVE; NON-LIMITING EMBODIMENTS OF THE INVENTION

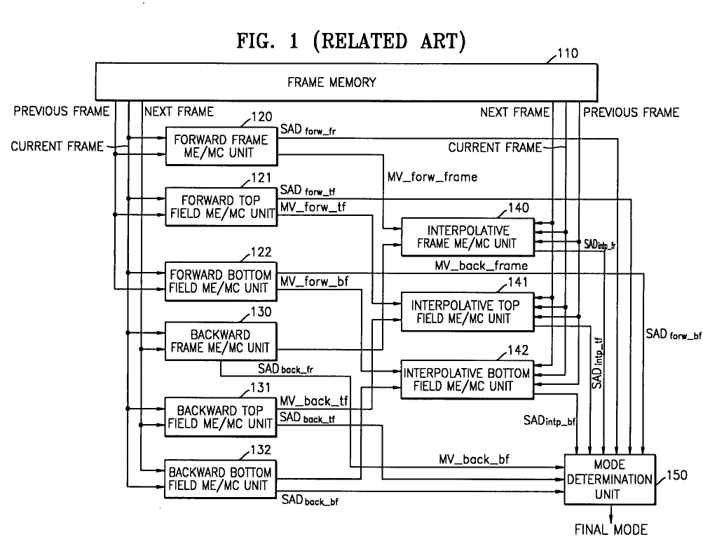

FIG. 1 is a block diagram of a frame memory and an ME unit for illustrating a conventional method of determining an MC mode of a moving picture encoding apparatus.

A method of determining an MC mode is not standardized. Therefore, the method of determining an MC mode of a B-picture in the general Test Model 5 (TM5) of MPEG-2 is described as an example.

A forward frame ME/MC unit 120, a forward top field ME/MC unit 121, and a forward bottom field ME/MC unit 122 each receive as inputs a previous frame and a current frame, and output a forward frame motion vector (MV) and a forward frame SAD (MV_forw_fr and SAD_forw_fr), a forward top field MV and a forward top field SAD (MV_forw_tf and SAD_forw_tf), and a forward bottom field MV and a forward bottom field SAD (MV_forw_bf and SAD_forw_bf), respectively.

A backward frame ME/MC unit 130, a backward top field ME/MC unit 131, and a backward bottom field ME/MC unit 132 each receive as inputs a current frame and a next frame, and output a backward frame MV and a backward frame SAD (MV_back_fr and SAD_back_fr), a backward top field MV and a backward top field SAD (MV_back_tf and SAD_back_tf), and a backward bottom field MV and a backward bottom field SAD (MV_back_bf and SAD_back_bf), respectively.

In the TM-5, an interpolative ME is not performed. Instead, an interpolative frame MC unit 140, an interpolative top field MC unit 141, and an interpolative bottom field MC unit 142 each receive as inputs forward/backward frame/field MVs, perform an interpolative MC, and output an interpolative frame SAD (SAD_intp_fr), an interpolative top field SAD (SAD_intp_tf), and an interpolative bottom field SAD (SAD_intp_bf), respectively.

An MC mode determination unit 150 compares the 9 SADs calculated and output by each unit described above to each other, and determines a final MC mode. The 9 SADs are an interpolative frame SAD (SAD_intp_fr), an interpolative top field SAD (SAD_intp_tf), an interpolative bottom field SAD (SAD_intp_bf), a forward frame SAD (SAD_forw_fr), a forward top field SAD (SAD_forw_tf), a forward bottom field SAD (SAD_forw_bf), a backward frame SAD (SAD_back_fr), a backward top field SAD (SAD_back_tf), and a backward bottom field SAD (SAD_back_bf). The final MC mode is determined by the following rule.

```
      If (SAD_intp_fr < SAD_intp_fld && SAD_intp_fr <
SAD_forw_fr && SAD_intp_fr < SAD_forw_fld &&
SAD_intp_fr < SAD_back_fr && SAD_intp_fr < SAD_back_fld){
      // interpolative frame MC mode
      }
      else if (SAD_intp_fld < SAD_forw_fr && SAD_intp_fld <
SAD_forw_fld && SAD_intp_fld < SAD_back_fr &&
SAD_intp_fld < SAD_back_fld) {
      // interpolative field MC mode
      }
      else if (SAD_forw_fr < SAD_forw_fld && SAD_forw_fr <
SAD_back_fr && SAD_forw_fr < SAD_back_fld){
      // forward frame MC mode
      }
      else if (SAD_forw_fld < SAD_back_fr && SAD_forw_fld <
SAD_back_fld){
      // forward field MC mode
      }
      else if (SAD_back_fr < SAD_back fld){
      // backward frame MC mode
      }
      else{
      // backward field MC mode
      }
```

where SAD_intp_fld is a sum of SAD_intp_tf and SAD_intp_bf, SAD_forw_fld is a sum of SAD_forw_tf and SAD_forw_bf, and SAD_back_fld is a sum of SAD_back_tf and SAD_back_bf. That is, if one SAD of each mode is a minimum value, the MC mode determination unit 150 outputs the MC mode corresponding to the SAD.

However, the conventional method of determining an MC mode shown in FIG. 1 must read a current frame, a previous frame, and a next frame from a frame memory with forward and backward MC results for interpolative MCs, and perform MCs again. Therefore, a considerable amount of computation must be performed and the size of a frame memory increases.

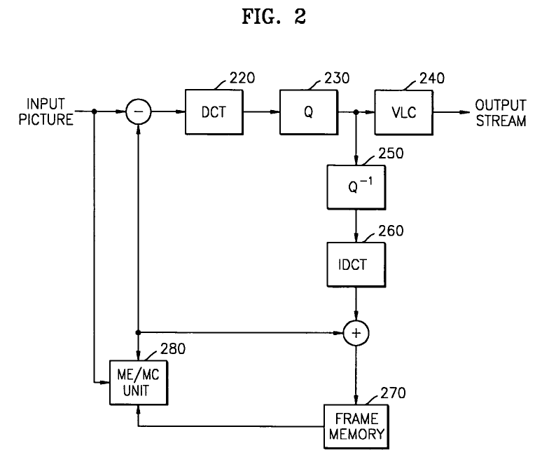

FIG. 2 is a block diagram of a moving picture encoding system according to the present invention.

First, input picture data is organized into units of groups of pictures (GOPs). A discrete cosine transform (DCT) unit 220 performs DCT in blocks of 8 by 8 in order to obtain a spatial redundancy of picture data. A quantization unit (Q) 230 quantizes DCT picture data from the DCT unit 220. The DCT picture data are DCT coefficients. An inverse-quantization unit (Q⁻¹) 250 inverse-quantizes picture data quantized in the quantization unit 230. An inverse DCT (IDCT) unit 260 performs IDCT on picture data inverse-quantized in the inverse-quantization unit 250. A frame memory (FM) unit 270 stores IDCT picture data from the IDCT unit 260 in units of frames. An ME/MC unit 280 estimates an MV and SAD per macro block using picture data of an input current frame and picture data of a stored previous frame. Lastly, a variable length coding (VLC) unit 240 removes statistical redundancy of quantized picture data according to the MV estimated in the ME/MC unit 280.

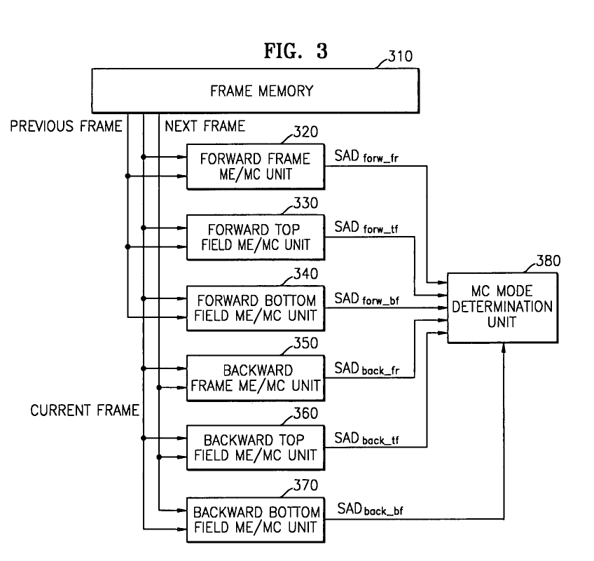

FIG. 3 is a detailed block diagram of the ME/MC unit 280 shown in FIG. 2.

A forward frame ME/MC unit 320, a forward top field ME/MC unit 330, and a forward bottom field ME/MC unit 340 each receive as inputs a previous frame and a current frame from a frame memory 310, and output a forward frame SAD (SAD_forw_fr), a forward top field SAD (SAD_forw_tf), and a forward bottom field SAD (SAD_forw_bf), respectively.

Also, a backward frame ME/MC unit 350, a backward top field ME/MC unit 360, and a backward bottom field ME/MC unit 370 each receive as inputs a current frame and a next frame from the frame memory 310, and output a backward frame SAD (SAD_back_fr), a backward top field SAD (SAD_back_tf), and a backward bottom field SAD (SAD_back_bf), respectively.

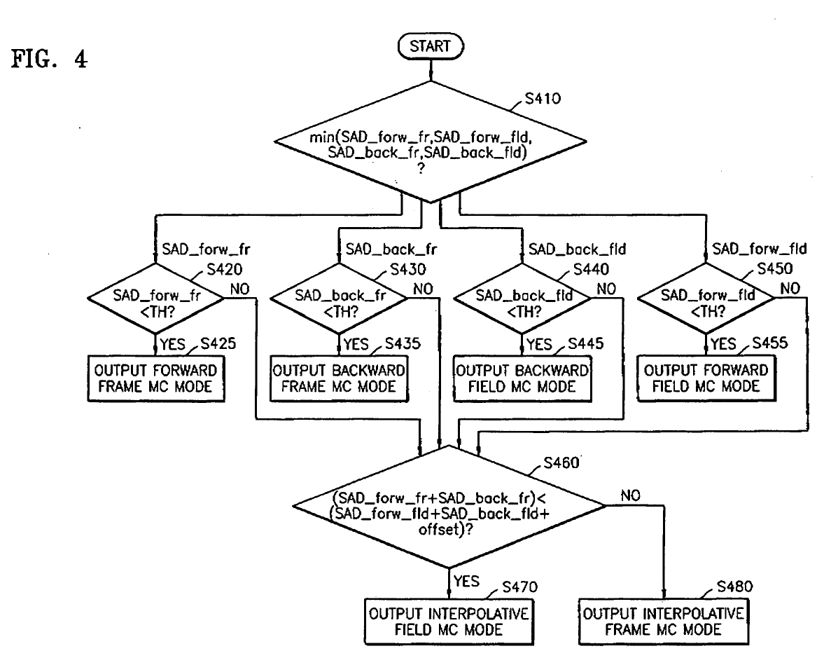

An MC mode determination unit 380 uses SAD information output from the forward frame ME/MC unit 320, the forward top field ME/MC unit 330, the forward bottom field ME/MC unit 340, the backward frame ME/MC unit 350, the backward top field ME/MC unit 360, and the backward bottom field ME/MC unit 370 to determine a final MC mode, as described in detail below with reference to FIG. 4.

FIG. 4 is a flowchart of a method of determining an MC mode according to the present invention.

If a sum of SAD_forw_tf and SAD_forw_bf is SAD_forw_fld, and a sum of SAD_back_tf and SAD_back_bf is SAD_back_fld, then a minimum value is determined as comparing 4 values, SAD_forw_fr, SAD_forw_fld, SAD_back_fr, and SAD_back_fld, to each other, in step S410.

If the minimum value is SAD_forw_fr, the MC mode determination unit 380 compares SAD_forw_fr to a predetermined threshold value (TH) in step S420. Here, if SAD_forw_fr is smaller than TH, the MC mode determination unit 380 outputs a forward frame MC mode in step S425, while if SAD_forw_fr is not smaller than TH, the MC mode determination unit 380 performs step S460 (described below). If the minimum value is SAD_back_fr, the MC mode determination unit 380 compares SAD_back_fr to TH in step S430. Here, if SAD_back_fr is smaller than TH, the MC mode determination unit 380 outputs a backward frame MC mode in step S435, while if SAD_back_fr is not smaller than TH, the MC mode determination unit 380 performs step S460. If the minimum value is SAD_back_fld, the MC mode determination unit 380 compares SAD_back_fld to TH in step S440. Here, if SAD_back_fld is smaller than TH, the MC mode determination unit 380 outputs a backward field MC mode in step S445, while if SAD_back_fld is not smaller than TH, the MC mode determination unit 380 performs step S460. Finally, if the minimum value is SAD_forw_fld, the MC mode determination unit 380 compares SAD_forw_fld to TH in step S450. Here, if SAD_forw_fld is smaller than TH, the MC mode determination unit 380 outputs a forward field MC mode in step S455, while if SAD_forw_fld is not smaller than TH, the MC mode determination unit 380 performs step S460.

According to experiment, it is preferable that TH is set at about 2000. If TH is larger than 2000, accuracy is low, because forward and backward ME are sometimes performed when interpolative ME should be performed. If TH is smaller than 2000, interpolative ME is sometimes performed when not necessary.

As described above, if the minimum value among SAD_forw_fr, SAD_forw_fld, SAD_back_fr, and SAD_back_fld is determined to be larger than or equal to TH in the relevant step among S420, S430, S440, and S450, then S460 is performed. In step S460, the MC mode determination unit 380 outputs one of a frame MC mode and a field MC mode as an interpolative MC mode. That is, if (SAD_forw_fr+SAD_back_fr)<(SAD_forw_fld+SAD_back_fld+OFFSET), the MC mode determination unit 380 outputs an interpolative frame MC mode in step S470, while if (SAD_forw_fr+SAD_back_fr)>(SAD_forw_fld+SAD_back_fld+OFFSET), the MC mode determination unit 380 outputs an interpolative field MC mode in step S480. Here, the value of OFFSET is determined by experiment, much like TH. The reason for OFFSET is to give priority to a frame mode. According to experiment, it is preferable that OFFSET is about 500.

Thus, according to the method described above, the MC mode determination unit 380 outputs one of the six MC modes.

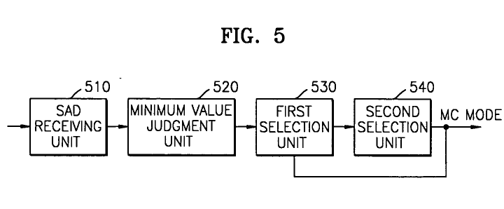

FIG. 5 is a block diagram of an apparatus for determining an MC mode according to the present invention. The apparatus for determining an MC mode comprises a SAD receiving unit 510, a minimum value judgment unit 520, a first selection unit 530, and a second selection unit 540.

The SAD receiving unit 510 receives a forward frame SAD, a sum of a forward top field SAD and forward bottom field SAD, a backward frame SAD, and a sum of a backward top field SAD and a backward bottom field SAD. The minimum value judgment unit 520 identifies one of the inputs listed above that has the lowest value. The first selection unit 530 selects a forward or backward MC mode corresponding to a minimum value.

For example, if the minimum value is the forward frame SAD and is smaller than a predetermined threshold value TH, the first selection unit 530 selects the forward frame MC mode. If the minimum value is the sum of the forward top field SAD and forward bottom field SAD and is smaller than TH, the first selection unit 530 selects the forward field MC mode. Meanwhile, if the minimum value is the backward frame SAD and is smaller than TH, the first selection unit 530 selects the backward frame MC mode. If the minimum value is the sum of the backward top field SAD and backward bottom field SAD and is smaller than TH, the first selection unit 530 selects the backward field MC mode.

The second selection unit 540, if the minimum value is not smaller than TH, selects one of an interpolative field MC mode and an interpolative frame MC mode, according to a predetermined condition made by combination of the SADs. That is, if (forward frame SAD+backward frame SAD) is smaller than (forward frame SAD+forward top field SAD+forward bottom field SAD+backward frame SAD+backward top field SAD+backward bottom field SAD+predetermined OFFSET), the second selection unit 540 outputs the interpolative frame MC mode. If (forward frame SAD+backward frame SAD) is not smaller than (forward frame SAD+forward top field SAD+forward bottom field SAD+backward frame SAD+backward top field SAD+backward bottom field SAD+predetermined OFFSET), the second selection unit 540 selects the interpolative field MC mode.

The present invention may be embodied in a general-purpose computer by running a program from a computer readable medium, including but not limited to storage media such as magnetic storage media (ROMs, RAMs, floppy disks, magnetic tapes, etc.), optically readable media (CD-ROMs, DVDs, etc.), and carrier waves (transmission over the Internet). The present invention may be embodied as a computer readable medium having a computer readable program code unit embodied therein for causing a number of computer systems connected via a network to effect distributed processing.

While the present invention has been particularly shown and described with reference to exemplary embodiments thereof, it will be understood by those of ordinary skill in the art that various changes in form and details may be made therein without departing from the spirit and scope of the present invention as defined by the following claims.

As described above, the method of determining an MC mode of the present invention reduces the amount of calculations and the amount of memory required because, in the case of an MPEG-2 encoder, the final MC mode is determined without performing interpolative MC in the ME mode unit.

1. A method for determining moving compensation (MC) mode, comprising:
(a) receiving as inputs a forward frame sum of absolute difference (SAD), a sum of a forward top field SAD and a forward bottom field SAD, a backward frame SAD, and a sum of a backward top field SAD and a backward bottom field SAD;
(b) identifying a minimum value of the inputs received in step (a);
(c) if the minimum value is smaller than a predetermined threshold value, selecting an MC mode corresponding to the minimum value; and
(d) if the minimum value is not smaller than the predetermined threshold value, selecting one of an interpolative field MC mode and an interpolative frame MC mode.

2. The method of claim 1, wherein step (c) comprises:
if the minimum value is a forward frame SAD and is smaller than the predetermined threshold value, selecting a forward frame MC mode, and if the minimum value is the sum of the forward top field SAD and the forward bottom field SAD and is smaller than the predetermined threshold value, selecting a forward field MC mode.

3. The method of claim 1, wherein step (c) comprises:
if the minimum value is the backward frame SAD and is smaller than the predetermined threshold value, selecting a backward frame MC mode, and if the minimum value is the sum of the backward top field SAD and the backward bottom field SAD and is smaller than the predetermined threshold value, selecting a backward field MC mode.

4. The method of claim 1, wherein step (d) comprises:
if the minimum value is not smaller than the predetermined threshold value and the sum of the forward frame SAD and the backward frame SAD is smaller than the sum of the forward frame SAD, the forward top field SAD, the forward bottom field SAD, the backward frame SAD, the backward top field SAD, the backward bottom field SAD, and a predetermined OFFSET, outputting the interpolative frame MC mode, and if the minimum value is not smaller than the predetermined threshold value and the sum of the forward frame SAD and the backward frame SAD is not smaller than the sum of the forward frame SAD, the forward top field SAD, the forward bottom field SAD, the backward frame SAD, the backward top field SAD, the backward bottom field SAD, and the predetermined OFFSET, selecting the interpolative field MC mode.

5. The method of claim 1, wherein in step (d), one of the interpolative frame MC mode and the interpolative field MC mode is selected according to a predetermined condition made by combination of SADs.

6. An apparatus for determining an MC mode, comprising:
a SAD receiving unit which receives as inputs a forward frame SAD, a sum of a forward top field SAD and a forward bottom field SAD, a backward frame SAD, and a sum of a backward top field SAD and a backward bottom field SAD;
a minimum value judgment unit which identifies a minimum value of the inputs received by the SAD receiving unit;
a first selection unit which selects an MC mode corresponding to the minimum value if the minimum value is smaller than a predetermined threshold value; and
a second selection unit which, if the minimum value is not smaller than the predetermined threshold value, selects one of an interpolative field MC mode and an interpolative frame MC mode.

7. The apparatus of claim 6, wherein if the minimum value is the forward frame SAD and is smaller than the predetermined threshold value, the first selection unit selects a forward frame MC mode, and if the minimum value is the sum of the forward top field SAD and the forward bottom field SAD and is smaller than the predetermined threshold value, the first selection unit selects a forward field MC mode.

8. The apparatus of claim 6, wherein if the minimum value is the backward frame SAD and is smaller than the predetermined threshold value, the first selection unit selects a backward frame MC mode, and if the minimum value is the sum of the backward top field SAD and the backward bottom field SAD and is smaller than the predetermined threshold value, the first selection unit selects a backward field MC mode.

9. The apparatus of claim 6, wherein if the minimum value is not smaller than the predetermined threshold value and the sum of the forward frame SAD and the backward frame SAD is smaller than the sum of the forward frame SAD, the forward top field SAD, the forward bottom field SAD, the backward frame SAD, the backward top field SAD, the backward bottom field SAD, and a predetermined OFFSET, the second selection unit outputs an interpolative frame MC mode, and if the minimum value is not smaller than the predetermined threshold value and the sum of the forward frame SAD and the backward frame SAD is not smaller than the sum of the forward frame SAD, the forward top field SAD, the forward bottom field SAD, the backward frame SAD, the backward top field SAD, the backward bottom field SAD, and the predetermined OFFSET, the second selection unit outputs an interpolative field MC mode.

10. The apparatus of claim 6, wherein the second selection unit selects one of the interpolative frame MC mode and the interpolative field MC mode according to a predetermined condition made by combination of SADs.

11. A picture encoding apparatus comprising:
a forward SAD calculation unit which calculates a forward frame SAD, a forward top field SAD, and a forward bottom field SAD;
a backward SAD calculation unit which calculates a backward frame SAD, a backward top field SAD, and a backward bottom field SAD; and
an MC mode determination unit which receives the SADs as inputs.

12. The apparatus of claim 11, wherein the MC mode determination unit comprises:
a SAD receiving unit which receives as inputs the forward frame SAD, a sum of the forward top field SAD and the forward bottom field SAD, the backward frame SAD, and a sum of the backward top field SAD and the backward bottom field SAD;
a minimum value judgment unit which identifies a minimum value among the inputs received by the SAD receiving unit;
a first selection unit which selects an MC mode corresponding to the minimum value if the minimum value is smaller than a predetermined threshold value; and
a second selection unit which, if the minimum value is not smaller than the predetermined threshold value, selects one of an interpolative field MC mode and an interpolative frame MC mode.

13. A computer readable medium recording a program for executing a method of determining an MC mode in a general-purpose computer, the method comprising:
(a) receiving as inputs a forward frame sum of absolute difference (SAD), a sum of a forward top field SAD and a forward bottom field SAD, a backward frame SAD, and a sum of a backward top field SAD and a backward bottom field SAD;
(b) identifying a minimum value of the inputs received in step (a);
(c) if the minimum value is smaller than a predetermined threshold value, selecting an MC mode corresponding to the minimum value; and
(d) if the minimum value is not smaller than the predetermined threshold value, selecting one of an interpolative field MC mode and an interpolative frame MC mode.
